(19) United States
(12) Patent Application Publication
(10) Pub. No.: US 2026/0034435 A1
(43) Pub. Date: Feb. 5, 2026

(54) VIRTUAL REALITY INTERACTION METHOD AND APPARATUS, SYSTEM, STORAGE MEDIUM, AND ELECTRONIC DEVICE

(71) Applicants: Beijing BOE Display Technology Co., Ltd., Beijing (CN); BOE TECHNOLOGY GROUP CO., LTD., Beijing (CN); Beijing BOE Technology Development Co., Ltd., Beijing (CN)

(72) Inventors: Weihua DU, Beijing (CN); Hao ZHANG, Beijing (CN); Lili CHEN, Beijing (CN); Peng HAN, Beijing (CN); Chaoquan YAO, Beijing (CN); Huidong HE, Beijing (CN); Juanjuan SHI, Beijing (CN); Ruifeng QIN, Beijing (CN); Qianwen JIANG, Beijing (CN)

(73) Assignees: Beijing BOE Display Technology Co., Ltd., Beijing (CN); BOE TECHNOLOGY GROUP CO., LTD., Beijing (CN); Beijing BOE Technology Development Co., Ltd., Beijing (CN)

(21) Appl. No.: 18/995,945

(22) PCT Filed: Apr. 19, 2024
(86) PCT No.: PCT/CN2024/088888

§ 371 Date: Jan. 17, 2025

(30) Foreign Application Priority Data
May 29, 2023 (CN) 202310620062.1

(51) Int. Cl. A63F 13/211; A63F 13/212; A63F 13/30; G02B 27/00; G02B 27/01; G06F 3/01

(52) U.S. Cl. CPC A63F 13/211; A63F 13/212; A63F 13/30; G02B 27/0093; G02B 27/017; G06F 3/012; G02B 2027/0178

(57) ABSTRACT

A virtual reality interaction method includes: collecting body posture information of a user in a real environment by using a posture tracking device, where the posture tracking device includes a motion detection unit provided corresponding to a position of a target skeletal muscle, and the motion detection unit is configured to determine a joint motion angle of a corresponding joint; collecting first position information of the user's head in the real environment by using a laser radar component, and collecting head posture information of the user's head in the real environment by using an inertial measurement unit component; and configuring the body posture information, the head position information, and the head posture information as full-body posture information of the user, and mapping a virtual object corresponding to the user in a virtual reality environment according to full-body posture information.

### CROSS-REFERENCE TO RELATED APPLICATIONS

This disclosure claims priority to Chinese application No. 202310620062.1, filed May 29, 2023 and titled “virtual reality interaction method and apparatus, system, storage medium, electronic device”, the entire contents of which are incorporated herein by reference in entirety.

### TECHNICAL FIELD

This disclosure relates to the field of virtual reality technology, and in particular to a virtual reality interaction method, a virtual reality interaction apparatus, a virtual reality system, a storage medium, and an electronic device.

### BACKGROUND

With the rapid development of virtual reality (VR) technology, it has been widely used in exhibitions, virtual training, e-sports, industrial simulation and other fields. Taking VR games as an example, the existing VR system can generally achieve head and hand tracking through input devices, but cannot achieve full-body tracking and use the tracking results in the interaction of the virtual environment. In addition, at the current stage, the VR system is mainly used in a single-player experience mode, which cannot maximize the virtual reality experience.

It should be noted that the information disclosed in the above background section is only used to enhance understanding the background of this disclosure, and therefore may include information that does not constitute the prior art known to those skilled in the art.

### SUMMARY

According to this disclosure, a virtual reality interaction method is provided and includes: collecting body posture information of a user in a real environment by using a posture tracking device, where the posture tracking device includes a motion detection unit provided corresponding to a position of a target skeletal muscle, and the motion detection unit is configured to determine a joint motion angle of a corresponding joint;
collecting first position information of the user's head in the real environment by using a laser radar component, and collecting head posture information of the user's head in the real environment by using an inertial measurement unit component; and
configuring the body posture information, the head position information, and the head posture information as full-body posture information of the user, and mapping a virtual object corresponding to the user in a virtual reality environment according to full-body posture information.

In some exemplary embodiments, the motion detection unit includes: a skin tension strain gauge and an electromyographic signal electrode configured to calculate the joint motion angle.

In some exemplary embodiments, the method further includes:
collecting magnitude and direction data of skeletal muscle stress through the skin tension strain gauge;
collecting corresponding electromyographic current data through the electromyographic signal electrode; and
determining the joint motion angle of the corresponding joint by querying a preset data table according to the electromyographic current data, the magnitude and direction data of the skeletal muscle stress.

In some exemplary embodiments, the method includes:
acquiring a user image of the user, and identifying the user image to acquire a corresponding body region image; and
calibrating the body region image to obtain length parameters corresponding to respective joints.

In some exemplary embodiments, the method includes:
sending the full-body posture information of the user to a server side, thereby causing the server side to display, based on the full-body posture information, the virtual object corresponding to the user in the virtual reality environment.

In some exemplary embodiments, the method includes:
configuring, in the virtual reality environment, a user virtual space for the virtual object corresponding to the user; and
displaying, in the user virtual space, the virtual object of the user based on the full-body posture information.

In some exemplary embodiments, the method further includes:
calibrating a coordinate sub-system corresponding to the user virtual space and a coordinate system corresponding to the virtual reality environment, thereby determining a coordinate transformation matrix between the coordinate sub-system corresponding to the user virtual space and the coordinate system corresponding to the virtual reality environment; and
determining, based on the coordinate transformation matrix and according to the full-body posture information of the virtual object corresponding to the user in the user virtual space, the full-body posture information of the virtual object corresponding to the user in the coordinate system corresponding to the virtual reality environment.

In some exemplary embodiments, the laser radar component and the inertial measurement unit component are arranged on a VR helmet worn by the user.

According to a second aspect of this disclosure, a virtual reality interaction apparatus is provided and includes:
a posture tracking device, adapted to collect body posture information of a user in a real environment, where the posture tracking device includes a motion detection unit provided corresponding to a position of a target skeletal muscle, and the motion detection unit is configured to determine a joint motion angle of a corresponding joint;
a laser radar component, adapted to collect first position information of the user's head in the real environment;
an inertial measurement unit component, adapted to collect head posture information of the user's head in the real environment; and
a full-body posture calculation module, adapted to configure the body posture information, the head position information, and the head posture information as full-body posture information of the user, and map a virtual object corresponding to the user in a virtual reality environment according to the full-body posture information.

According to a third aspect of this disclosure, a virtual reality interaction system is provided and includes:
a user terminal device, configured to collect user data, where the user data includes full-body posture information of a user in a real environment, and the full-body posture information includes head position information, head posture information, and body posture information; and
a server side, configured to acquire user data of multiple users, and display, according to correspondences between the multiple users and virtual objects in a virtual reality environment, a virtual object corresponding to the user based on the full-body posture information in the virtual reality environment.

According to a fourth aspect of this disclosure, a storage medium is provided and has a computer program stored thereon, where the computer program, when being executed by a processor, is used for implementing the virtual reality interaction method described above.

According to a fifth aspect of this disclosure, an electronic device is provided and includes:
a processor; and
a memory, configured to store executable instructions of the processor;
where the processor is configured to, through executing the executable instructions, implement the virtual reality interaction method described above.

It is to be understood that the foregoing general description and the following detailed description are exemplary and explanatory only and are not restrictive of this disclosure.

### BRIEF DESCRIPTION OF THE DRAWINGS

The drawings herein are incorporated into the specification and constitute apart of the specification, showing embodiments consistent with this disclosure, and together with the specification, are used to explain the principles of this disclosure. The drawings described below are only some embodiments of this disclosure, and for those skilled in the art, other drawings can be obtained based on these drawings without creative work. In the drawings:

FIG. 1 schematically shows a schematic diagram of an exemplary system architecture in an exemplary embodiment of this disclosure that applies a technical solution according to an embodiment of this disclosure;

FIG. 2 schematically shows a schematic diagram of a virtual reality interaction method according to an exemplary embodiment of this disclosure;

FIG. 3 schematically shows a schematic diagram of a user wearing a VR helmet according to an exemplary embodiment of this disclosure;

FIG. 4 schematically shows a schematic diagram of wearing a posture tracking device in an exemplary embodiment of this disclosure;

FIG. 5 schematically shows a schematic diagram of a correspondence between a real space coordinate system and a user virtual space coordinate system in an exemplary embodiment of this disclosure;

FIG. 6 schematically shows a schematic diagram of a hand tracking coordinate system conversion in an exemplary embodiment of this disclosure;

FIG. 7 schematically shows a system block diagram in an exemplary embodiment of this disclosure;

FIG. 8 schematically shows a schematic diagram of coordinate transformation for multi-user interaction in an exemplary embodiment of this disclosure;

FIG. 9 schematically shows a schematic diagram of a virtual reality interaction apparatus in an exemplary embodiment of this disclosure;

FIG. 10 schematically shows a schematic diagram of a virtual reality interaction system in an exemplary embodiment of this disclosure; and

FIG. 11 schematically shows a composition diagram of an electronic device in an exemplary embodiment of this disclosure.

### DETAILED DESCRIPTION

Exemplary embodiments will now be described more fully with reference to the accompanying drawings. However, exemplary embodiments can be implemented in a variety of forms and should not be construed as limited to the examples set forth herein: rather, these embodiments are provided so that this disclosure will be more comprehensive and complete and to fully convey the concepts of the exemplary embodiments to those skilled in the art. The described features, structures, or characteristics may be combined in any suitable manner in one or more embodiments.

In addition, the accompanying drawings are only schematic illustrations of this disclosure and are not necessarily drawn to scale. The same reference numerals in the drawings represent the same or similar parts, and thus their repeated description will be omitted. Some of the block diagrams shown in the accompanying drawings are functional entities and do not necessarily correspond to physically or logically independent entities. These functional entities can be implemented in software form, or implemented in one or more hardware modules or integrated circuits, or implemented in different networks and/or processor devices and/or microcontroller devices.

In the related art, in the application scenarios of virtual reality, the experience mode is mainly a single-player scenario, which cannot maximize the experience of virtual reality. The general VR system can only track the head and hands, but in the real scene, our full-body can participate in the interaction with the surrounding environment, so the full-body tracking and the tracking results can be used to interact with the virtual environment, which greatly promotes the experience of virtual reality.

In view of the shortcomings and deficiencies of the related art, a virtual reality interaction method is provided in some exemplary implementation, which can be applied to application scenarios of virtual reality interaction. Referring to FIG. 2, a virtual reality interaction method as provided may include following steps.

In step S11, body posture information of a user in areal environment is collected by using a posture tracking device, where the posture tracking device includes a motion detection unit provided corresponding to the distribution of human skeletal muscles, and the motion detection unit is configured to determine a joint motion angle of a corresponding joint.

In step S12, first position information of the user's head in the real environment is collected by using a laser radar component, and head posture information of the user's head in the real environment is collected by using an inertial measurement unit (IMU) component.

In step S13, the body posture information, head position information, and head posture information are configured into full-body posture information of the user, so as to map a virtual object corresponding to the user in a virtual reality environment according to the full-body posture information.

In the virtual reality interaction method according to some exemplary embodiments, by providing the posture tracking device, multiple motion detection units can be used to collect the joint motion angles of respective joints of the user's body trunk, so that the body posture information can be determined based on the joint motion angles. Also, the laser radar component is configured to accurately collect the first position information of the user in the real environment, and the IMU component is configured to collect the head posture information of the user's head in the real environment, so as to obtain the user's full-body posture information. Based on the full-body posture information, the user's virtual object motions in the virtual reality environment can be accurately mapped, thereby improving the accuracy of the virtual object's interactive motions in the virtual reality environment and, thus, improving the user's usage experience.

Each step of the virtual reality interaction method in some exemplary embodiments will be described as follows in more detail with reference to the accompanying drawings and embodiments.

In step S11, the body posture information of the user in the real environment is collected by using the posture tracking device, where the posture tracking device includes the motion detection unit provided corresponding to the distribution of human skeletal muscles, and the motion detection unit is configured to determine the joint motion angle of the corresponding joint.

In some exemplary embodiments, the motion detection unit includes: a skin tension strain gauge and an electromyographic signal electrode for respectively calculating the joint motion angle.

In some exemplary embodiments, the method further includes: collecting magnitude and direction data of skeletal muscle stress through the skin tension strain gauge; collecting corresponding electromyographic current data through the electromyographic signal electrode; and determining the joint motion angle of the corresponding joint by querying a preset data table based on the electromyographic current data, the magnitude and direction data of skeletal muscle stress.

Specifically, at the user terminal device side, posture tracking devices may be respectively provided for each user. The posture tracking device may be a wearable system. For example, it may include a set of tights, on which motion detection units are arranged corresponding to the distribution of skeletal muscles of the human body. The above-mentioned target skeletal muscles may include all or part of the skeletal muscles selected corresponding to the skeletal muscles of the human body.

In some embodiments, when it is to obtain accurate posture information of each joint of the user, the motion detection units can be arranged at each skeletal muscle position or the main skeletal muscle positions of the human body according to the distribution of the skeletal muscles of the human body. Alternatively, in some scenarios, if only the brief posture information of the main trunk of the human body is to be obtained, the motion detection unit(s) can be arranged at the pre-selected trunk position(s) and the skeletal muscle position(s) corresponding to the joint(s). For example, motion detection units can be arranged at the skeletal muscle positions corresponding to the elbow joint, wrist joint, knee joint and ankle joint.

Alternatively, in order to obtain more accurate joint motion angle data, multiple detection units can also be arranged at each motion joint. For example, as shown in FIG. 4, a first elbow joint motion detection unit 41 and a second elbow joint motion detection unit 42 can be arranged at the elbow joint. The motion detection unit is mainly composed of a skin tension strain gauge 401 and an electromyographic signal electrode 402. The motion detection unit may include a microcontroller unit (MCU), which may be connected to the electromyographic signal electrode and the skin tension strain gauge through a bandpass amplifier(s), and may be configured to perform A/D conversion on the received signal to calculate the joint motion angle. Specifically, during the contraction or relaxation of skeletal muscle, the skin tension strain gauge will be deformed due to the contraction or relaxation of the skin, and the strain gauge will generate pressure or tension, with the generated force being different depend on the degree of contraction or relaxation of the skeletal muscle. In this way, the movement of the skeletal muscle can be determined by the magnitude and direction of the force (pressure or tension), and then the motion angle of the corresponding joint can be obtained. The working mode of the electromyographic signal electrode is similar to that of the skin tension strain gauge. When the skeletal muscle contracts, an electromyographic current will be generated, and the magnitude of the electromyographic current changes with the degree of muscle contraction. The electromyographic signal electrode is thus used to detect the electromyographic current, and the magnitude of the current can be used to determine the contraction degree of the skeletal muscle, then the motion angle of the corresponding joint can be obtained. The skin tension strain gauge and the electromyographic signal electrode seem to have the same effect, but in reality, the electromyographic signal is only generated on the contraction side of the muscle, but not on the relaxation side. However, the skin tension strain gauge will still generate tension when the muscle relaxes.

In order to obtain accurate joint angle information, data collection can be performed in advance to record the joint angles corresponding to the force and electromyographic current, and a data table can be established based on the collected data. For the currently obtained electromyographic current and skin stress values, the corresponding joint angle data can be determined by querying the data table. If there is no corresponding electromyographic current value or stress value in the data table, the joint angle corresponding to the electromyographic current value and stress value with the smallest numerical error can be selected in the data table as the final joint angle data. In this way, the motion angles of joints in various parts of the human body can be obtained by the motion detection units arranged in various parts of the human body, and then the full-body posture can be obtained. When multiple groups of motion detection units are provided at the same joint, multiple groups of joint angle data can be obtained, and the calculated average value can be used as the final joint angle data.

In step S12, the first position information of the user's head in the real environment is collected by using the laser radar component, and the head posture information of the user's head in the real environment is collected by using the IMU component.

In some exemplary embodiments, the laser radar component and the IMU component are arranged on a VR helmet worn by the user.

In some exemplary embodiments, when a user uses a VR device for virtual reality interaction, each user may pre-select a real space of a preset size in the real environment, so that the user's posture data in the real space can be collected. Specifically, for each user, when using a VR device for virtual reality interaction, a real space of uniform size can be pre-selected in the real environment as the user's experience space in the real environment. In an application scenario where multiple people interact with the same virtual scene in different real environments, each user is to find an experience space in his or her own real space, select a fixed position in the experience space, and calibrate the coordinate system of the experience space based on the fixed position, so as to unify the scale standards among the users. Since the length and width of the real space selected by each user are consistent, correspondingly, user virtual spaces of the same size and area can be mapped to respective users' virtual objects in the virtual reality environment, thereby facilitating to tracking the real-time posture of the user in the entire virtual reality environment.

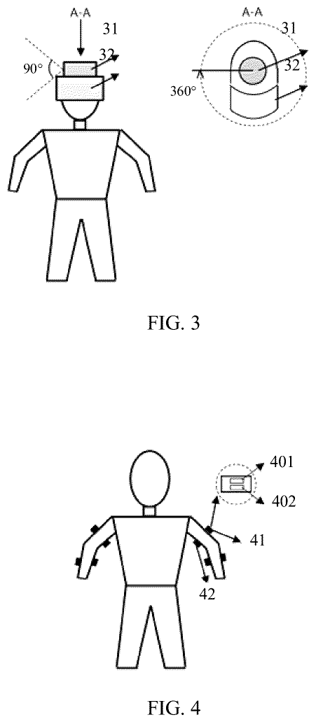

Specifically, as shown in FIG. 3, the VR helmet includes VR glasses 32, and a multi-line laser radar 31 can be installed on an existing VR helmet and can be configured to achieve 360-degree omnidirectional tracking of the user's head. In related art, the VR system mainly uses vSLAM (Visual Simultaneous Localization and Mapping) of the binocular camera to track the head position of the experiencer, but cannot achieve 360-degree omnidirectional tracking of the experiencer. However, according to this disclosure, the position coordinates of the user's head relative to the earth reference point in the real environment can be acquired by using the multi-line laser radar, and the advantage of using the laser radar instead of the binocular camera is that, no matter how many degrees the user rotates relative to the reference point, the laser radar can directly capture the user's current position relative to the reference point. The reason lies in that the laser radar will detect the obstacle distance of the 360-degree surrounding horizontal direction in real time at a certain frequency, and can directly calculate its own position coordinates in the reference coordinates faster. In related art, when the binocular camera is facing away from the reference point, only the rotation angle of the experiencer relative to the reference point can be calculated by the IMU, and the position information of the experiencer's head can only be obtained indirectly, where indirect calculation will inevitably lead to greater errors. In addition, the use of multi-line laser radar can obtain the height information of the user's head. The multi-line laser radar can also detect the surrounding horizontal and vertical obstacles in real time, and can obtain the position coordinates (x, y, z) of the head of the user wearing the VR helmet, so that the VR helmet can track the position information of the user's head. In combination with the IMU component of the VR helmet, the posture coordinates (α, β, γ) of the user's head can be obtained in real time, which are the rotation angles around the x-axis, y-axis, and z-axis respectively, so that the posture information of the user's head can be tracked. The multi-line laser radar combined with the IMU can obtain the six-degree-of-freedom (six-DoF) posture coordinates of the user's head.

In step S13, the body posture information, head position information, and head posture information are configured into full-body posture information of the user, so as to map the virtual object corresponding to the user in the virtual reality environment according to the full-body posture information.

In some exemplary embodiments, generally speaking, the posture information includes position and posture information of an object in the coordinate system. For each user, the first position information of the head in the experience space collected by the laser radar component can be used as the position information of the user's full-body. In addition, the head posture information and body posture information can be used as the user's full-body posture information. Based on the currently collected body posture information, head position information, and head posture information, the full-body posture information of the user can be provided.

For the terminal device, after collecting the full-body posture information, the data can be sent to the virtual reality server. Thus, the virtual objects of each user can be mapped in the virtual reality environment established on the server side.

In some exemplary embodiments, the method includes: sending the full-body posture information corresponding to the user to the server, so that the server displays, based on the full-body posture information, a virtual object of the user in the virtual reality environment.

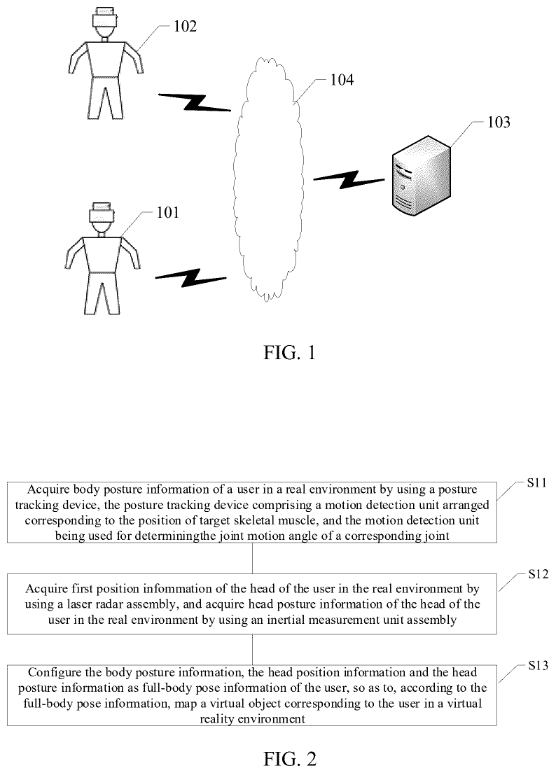

In some exemplary embodiments, with reference to FIG. 1, a schematic diagram of an exemplary system architecture to which the technical solution of an embodiment of this disclosure can be applied is shown. As shown in FIG. 1, the system architecture may include a terminal device (101, 102 shown in FIG. 1), a network 104, and a server 103. Herein, the above-mentioned terminal device is an intelligent VR device worn by the user, including VR devices such as a VR helmet, a VR handle, and a body posture detection device, which is used to immerse the user in a virtual reality environment. The network 104 is used to provide a medium for a communication link between the terminal devices and the server 105. The network 104 may include various connection types, such as a wired communication link, a wireless communication link, and the like. It should be understood that the number of terminal devices, networks, and servers in FIG. 1 is only schematic. According to the implementation requirements, there may be any number of terminal devices, networks, and servers. For example, the server 103 may be a server cluster composed of multiple servers. For example, the content of the above-mentioned virtual reality interaction method can be implemented on the terminal device side. The full-body posture information collected by the user side can be sent to the server side, a virtual reality environment and virtual objects of each user are established on the server side, and motions of the virtual objects can be controlled according to the full-body posture information.

In some exemplary embodiments, the method includes: configuring a user virtual space for a virtual object corresponding to the user in the virtual reality environment; and
displaying the virtual object of the user in the user virtual space based on the full-body posture information.

Specifically, respective user virtual spaces can be mapped to each user's real space, virtual objects corresponding to the users can be displayed in the respective user virtual spaces, and the coordinate system conversion relationship between the user's user virtual space and the virtual reality system is to be determined.

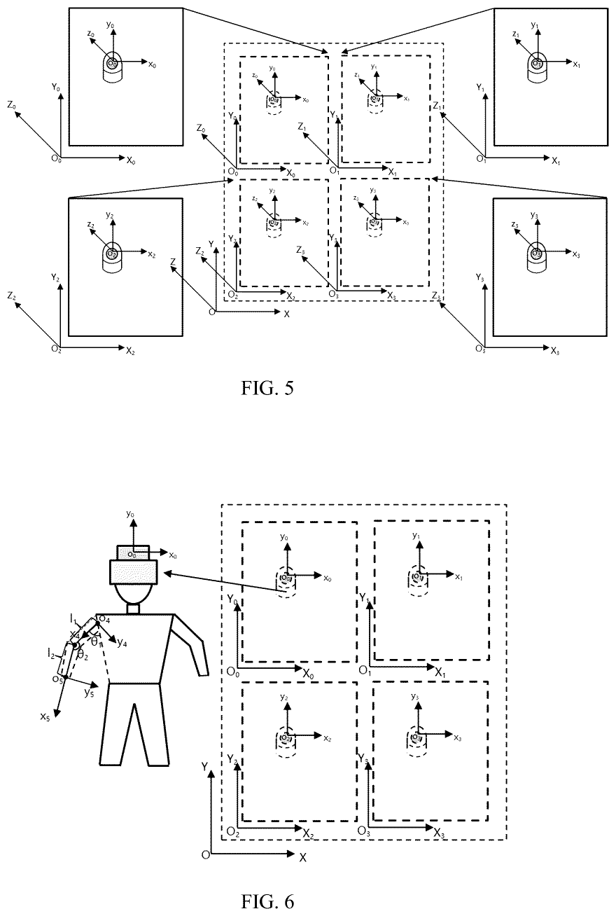

As shown in FIG. 5, according to the requirements of the scene, in the virtual reality environment coordinate system XYZ, a corresponding user virtual space is divided for each user. A reference point can be selected for each user virtual space, and the reference point is fixed at a fixed position in the virtual display environment. Then a coordinate sub-system of the user virtual space is established based on the reference point, such as coordinate systems X0Y0Z0, X1Y1Z1, X2Y2Z2, and X3Y3Z3, and the position of each coordinate sub-system relative to the virtual environment coordinate system XYZ is fixed. In this way, the position of each user's virtual object relative to the reference point (coordinate system XOY) in the virtual reality environment can be obtained. The mapping process of FIG. 5 only shows the mapping of the three-DoF position.

In some exemplary embodiments, the method includes: calibrating the coordinate sub-system corresponding to the user virtual space and the virtual reality environment coordinate system, so as to determine a coordinate transformation matrix between the coordinate sub-system corresponding to the user virtual space and the virtual reality environment coordinate system; and
determining, based on the coordinate transformation matrix, and according to the full-body posture information of the virtual object corresponding to the user in the user virtual space, the full-body posture information of the virtual object corresponding to the user in the virtual reality environment coordinate.

Specifically, the head-mounted device worn by the user can track the dynamic position of the user's head (e.g., in the coordinate system x0oy0z0) relative to the reference point of the virtual reality space (e.g. the coordinate system X0Y0Z0), and the rotation angles of the user's full-body joints can be captured by the motion detection units. In this way, the virtual object corresponding to the user can be mapped in the virtual environment based on the captured user's full-body posture, so as to map the user in the virtual display environment. As the user changes dynamically, the dynamic changes of the virtual object relative to the virtual reality space can also be captured, so that each user's virtual space is mapped to the same virtual reality environment.

For the position and posture of a virtual object in the virtual reality environment, taking the tracking of a user's hand posture relative to the virtual space as an example, as shown in FIG. 6, it is to determine the relative coordinates of the coordinate system x5o5y5 relative to the coordinate system XOY For example:

$${M}_{{Oo}_{5}} = {M}_{{OO}_{O}} * {M}_{{O}_{o} {o}_{o}} * {M}_{{o}_{o} {o}_{4}} * {M}_{{o}_{4} {o}_{5}}$$

Here, M_{Oo5} is the coordinate transformation matrix of coordinate system x₅o₅y₅ relative to coordinate system XOY.

For example, the calculation process of the transformation matrix Mₒ_{₄}ₒ_{₅} may be as follows:

$${M}_{{o}_{4} {o}_{5}} = {M}_{{o}_{4} {θ}_{1}} \times {M}_{{θ}_{1} {θ}_{2}} \times {M}_{{θ}_{2} {o}_{5}}$$

$${M}_{{o}_{4} {θ}_{1}} = Rot ( {z}_{{0}_{4} {θ}_{1}} , {θ}_{1} ) = [ \begin{matrix}c {θ}_{1} & - s {θ}_{1} & 0 & 0 \\ s {θ}_{1} & c {θ}_{1} & 0 & 0 \\ 0 & 0 & 1 & 0 \\ 0 & 0 & 0 & 1\end{matrix} ]$$

$${M}_{{θ}_{1} {θ}_{2}} = Rot ( {z}_{{θ}_{1} {θ}_{2}} , {θ}_{1} ) \times Trans ( {l}_{1} , 0 , 0 ) = [ \begin{matrix}c {θ}_{1} & - s {θ}_{1} & 0 & 0 \\ s {θ}_{1} & c {θ}_{1} & 0 & 0 \\ 0 & 0 & 1 & 0 \\ 0 & 0 & 0 & 1\end{matrix} ] \times [ \begin{matrix}1 & 0 & 0 & {l}_{1} \\ 0 & 1 & 0 & 0 \\ 0 & 0 & 1 & 0 \\ 0 & 0 & 0 & 1\end{matrix} ] = [ \begin{matrix}c {θ}_{1} & - s {θ}_{1} & 0 & {l}_{1} c {θ}_{1} \\ s {θ}_{1} & c {θ}_{1} & 0 & {l}_{1} s {θ}_{1} \\ 0 & 0 & 1 & 0 \\ 0 & 0 & 0 & 1\end{matrix} ]$$

$${M}_{{θ}_{2} {o}_{5}} = Rot ( {z}_{{θ}_{2} {o}_{5}} , {θ}_{2} ) \times Trans ( {l}_{2} , 0 , 0 ) = [ \begin{matrix}c {θ}_{2} & - s {θ}_{2} & 0 & 0 \\ s {θ}_{1} & c {θ}_{2} & 0 & 0 \\ 0 & 0 & 1 & 0 \\ 0 & 0 & 0 & 1\end{matrix} ] \times [ \begin{matrix}1 & 0 & 0 & {l}_{2} \\ 0 & 1 & 0 & 0 \\ 0 & 0 & 1 & 0 \\ 0 & 0 & 0 & 1\end{matrix} ] = [ \begin{matrix}c {θ}_{2} & - s {θ}_{2} & 0 & {l}_{2} c {θ}_{2} \\ s {θ}_{2} & c {θ}_{2} & 0 & {l}_{2} s {θ}_{2} \\ 0 & 0 & 1 & 0 \\ 0 & 0 & 0 & 1\end{matrix} ]$$

Here, Mₒ_{₄}_{θ}_{₁} is the coordinate transformation matrix of θ₁ relative to o₄; cθ₁ is cos θ₁; sθ₁ is sin θ₁; l₁ is the length of the upper arm; l₂ is the length of the forearm; θ₁ is the rotation angle of the shoulder joint; θ₂ is the rotation angle of the elbow joint; l₁ and l₂ are obtained by taking pictures of the human body, and θ₁ and θ₂ are obtained by the motion detection units.

In some exemplary embodiments, the method includes: acquiring a user image of the user, identifying the user image to acquire a corresponding body region image; and calibrating the body region image to acquire length parameters corresponding to each joint.

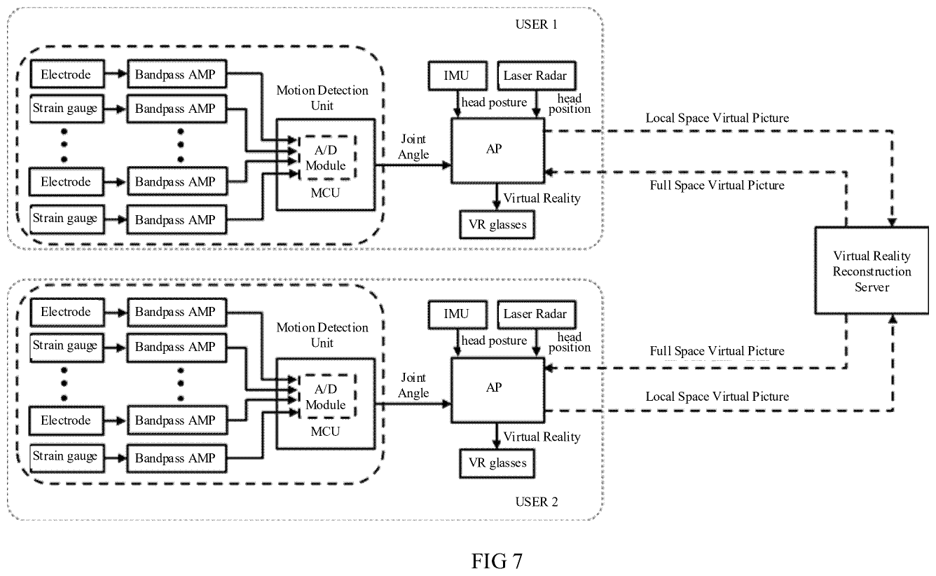

For example, referring to FIG. 7, taking two experiencer users distributed in different real locations as an example, when using the virtual reality interaction system, the user can first upload his/her full-body photo to the terminal device or server end, so as to enable the length information between the joints of the human body to be calculated as the basis for kinematic calculation. The rotation angles of the joints of the full-body can be obtained through the motion detection units. Then, combined with the IMU and the laser radar, the relative posture coordinates of the user's full-body relative to the real reference point can be obtained. The real scene and the user can be virtualized through the AP (application processor) of the wearable system. Because this part of the virtualized scene only includes the processing of a single user, a local space virtual picture is obtained. Subsequently, the AP transmits the local space virtual picture to the remote virtual reality reconstruction server through the network. In this way, the virtual reality reconstruction server reconstructs the local space virtual pictures sent by all users into a global space virtual scene according to the experience scene selected by the player, and then distributes it to the AP end of each user for virtual reality display. Therefore, each user can see the virtual pictures of other users in the virtual reality display. Through this interactive mode, users distributed in different real locations can participate in completing some interactive experiences of a multiplayer virtual game.

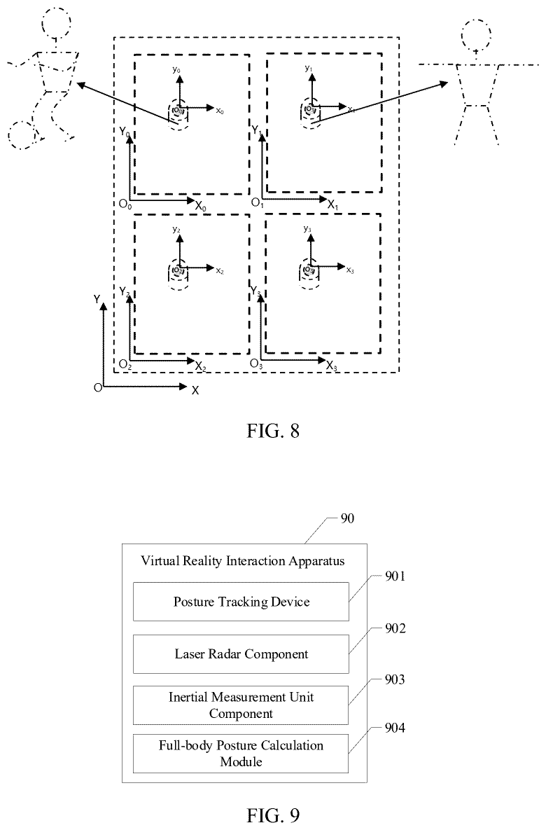

For example, referring to FIG. 8, taking multiplayer football as an example, in a virtual reality environment, corresponding user virtual spaces can be divided for virtual objects of each user, and the virtual reality scene can correspond to the real space of each user. In the initial state, the initial position of the user's virtual object can be displayed in the user virtual space. Football is a virtual object in the virtual reality environment. If a user wants to control the toe of his/her corresponding virtual object to kick the virtual football, he/she is to know the specific position of the virtual object's feet in the virtual reality environment. Moreover, the position of the virtual football in the virtual reality environment is known. According to this solution, the posture of the user's full-body can be tracked, so it can be realized to control the motion state of the corresponding virtual object through the user's full-body posture, for example, to realize the kicking action and the goalkeeper's defensive action. In addition, different strengths when kicking the ball can be realized according to different amplitudes of the swing leg when the user kicks the ball. According to the strength, the virtual football is caused to shuttle through the user virtual spaces of different users in the virtual reality environment, thereby realizing the passing action. The forgoing process realizes multi-person interaction in the virtual scene.

The virtual reality interaction method provided by the disclosed embodiments can realize real-time and accurate collection of the user's head position information, head posture information, and body posture information in the real space by assembling the laser radar on the VR helmet and the posture tracking device worm by the user, so as to realize 6DOF tracking of the full-body posture. The full-body tracking is realized and the tracking results are involved in the interaction of the virtual environment, thereby greatly promoting the improvement of the virtual reality experience. By creating corresponding virtual objects for each user in the virtual reality environment, the real space of each user is mapped to the corresponding user virtual space, so that users in different locations can interact in the scene of the same virtual reality environment.

It should be noted that the above drawings are only schematic illustrations of the processes included in the method according to some exemplary embodiments of this disclosure, and are not intended to be limiting. It is easy to understand that the processes shown in the above drawings do not indicate or limit the time sequence of these processes. In addition, it is also to be understood that these processes can be performed synchronously or asynchronously, for example, in multiple modules.

Further, referring to FIG. 9, a virtual reality interaction apparatus 90 is also provided in some embodiments of this example, which can be applied to a virtual reality user terminal device. The apparatus includes: a posture tracking device 901, a laser radar component 902, an IMU component 903, and a full-body posture calculation module 904 detailed as follows.

The posture tracking device 901 is configured to collect body posture information of a user in a real environment, where the posture tracking device includes a motion detection unit provided corresponding to a position of a target skeletal muscle, and the motion detection unit is configured to determine a joint motion angle of a corresponding joint.

The laser radar component 902 is configured to collect first position information of the user's head in the real environment.

The IMU component 903 is configured to collect head posture information of the user's head in the real environment.

The full-body posture calculation module 904 is adapted to configure the body posture information, the head position information, and the head posture information as full-body posture information of the user, and map a virtual object corresponding to the user in a virtual reality environment according to the full-body posture information.

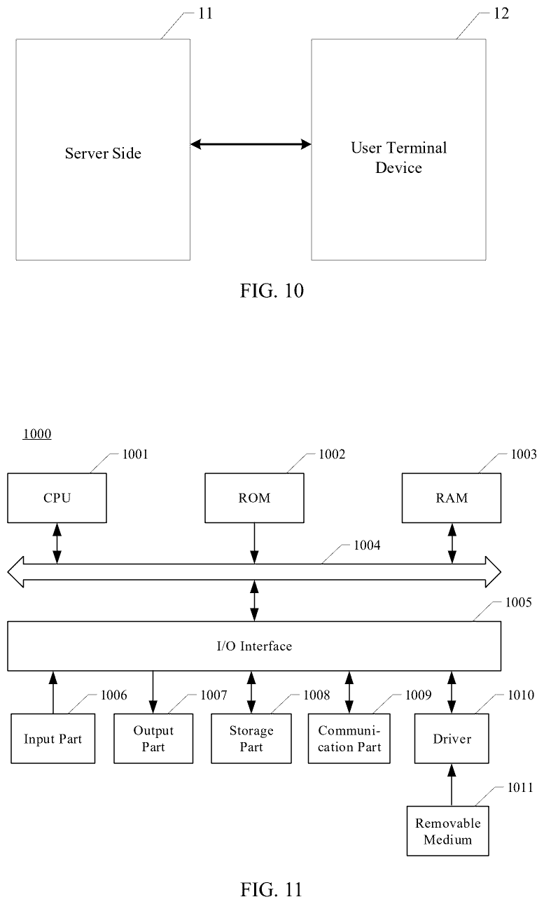

Furthermore, referring to FIG. 10, a virtual reality interaction system is also provided in some embodiments of this example. The system includes a server 11 and a user terminal device 12.

The user terminal device 12 is configured to collect user data, where the user data includes full-body posture information of a user in a real environment, and the full-body posture information includes head position information, head posture information, and body posture information.

The server side 11 is configured to acquire user data of multiple users, and display, according to correspondences between the multiple users and virtual objects in a virtual reality environment, a virtual object corresponding to the user based on the full-body posture information in the virtual reality environment.

It should be noted that, although several modules or units of the apparatus for action execution are mentioned in the above detailed description, this division is not mandatory. In fact, according to the embodiments of this disclosure, the features and functions of two or more modules or units described above can be embodied in one module or unit. On the contrary, the features and functions of one module or unit described above can be further divided into multiple modules or units to be embodied.

FIG. 11 is a schematic diagram showing an electronic device suitable for implementing some embodiments of this disclosure.

It should be noted that the electronic device 1000 shown in FIG. 11 is only an example and should not bring any limitation to the functions and scope of use of the embodiments of this disclosure.

As shown in FIG. 11, the electronic device 1000 includes a central processing unit (CPU) 1001, which can perform various appropriate actions and processes according to a program stored in a read-only memory (ROM) 1002 or a program loaded from a storage part 1008 to a random access memory (RAM) 1003. For example, the central processing unit 101 can perform the steps shown in FIG. 12 to implement the above-mentioned method. Various programs and data required for system operation are also stored in the RAM 1003. The CPU 1001, the ROM 1002, and the RAM 1003 are connected to each other via a bus 1004. An input/output (I/O) interface 1005 is also connected to the bus 1004.

The following components are connected to the I/O interface 1005; an input part 1006 including a keyboard, a mouse, etc.; an output part 1007 including a cathode ray tube (CRT), a liquid crystal display (LCD), and a speaker, etc.; a storage part 1008 including a hard disk, etc.; and a communication part 1009 including a network interface card such as a local area network (LAN) card, a modem, etc. The communication part 1009 performs communication processing via a network such as the Internet. A driver 1010 is also connected to the I/O interface 1005 as needed. A removable medium 1011, such as a magnetic disk, an optical disk, a magneto-optical disk, a semiconductor memory, etc., is installed on the driver 1010 as needed so that a computer program read therefrom is installed into the storage part 1008 as needed.

In particular, according to some embodiments of this disclosure, the process described below with reference to the flowchart can be implemented as a computer software program. For example, some embodiments of this disclosure provide a computer program product, which includes a computer program carried on a storage medium, and the computer program contains program code for implementing the method shown in the flowchart. In such an embodiment, the computer program can be downloaded and installed from a network through the communication part 1009, and/or installed from a removable medium 1011. When the computer program is executed by the CPU 1001, various functions defined in the system of the present application are executed.

Specifically, the electronic device can be a server, a tablet computer, a laptop or other intelligent device, and can implement the IoT device interaction management method applied to the proxy server or IoT platform. Alternatively, the electronic device can also be an IoT device, and can implement the IoT device interaction management method applied to the IoT device.

It should be noted that the storage medium shown in the embodiments of this disclosure may be a computer-readable signal medium or a computer-readable storage medium or any combination of the above two. The computer-readable storage medium may be, for example, but not limited to, an electrical, magnetic, optical, electromagnetic, infrared, or semiconductor system, apparatus or device, or any combination of the above. More specific examples of computer-readable storage medium may include, but are not limited to: an electrical connection with one or more wires, a portable computer disk, a hard disk, a random access memory (RAM), a read-only memory (ROM), an erasable programmable read-only memory (EPROM), a flash memory, an optical fiber, a portable compact disc read-only memory (CD-ROM), an optical storage device, a magnetic storage device, or any suitable combination of the above. In this disclosure, a computer-readable storage medium may be any tangible medium containing or storing a program, which may be used by or in combination with an instruction execution system, apparatus or device. In this disclosure, a computer-readable signal medium may include a data signal propagated in a baseband or as part of a carrier wave, which carries a computer-readable program code. Such propagated data signals may take a variety of forms, including but not limited to electromagnetic signals, optical signals, or any suitable combination of the above. Computer-readable signal medium may also be any storage medium other than computer-readable storage medium, which can send, propagate, or transmit programs for use by or in conjunction with an instruction execution system, apparatus, or device. The program code contained on the storage medium may be transmitted using any appropriate medium, including but not limited to: wireless, wired, etc., or any suitable combination of the above.

The flow chart and block diagram in the accompanying drawings illustrate the possible architecture, function and operation of the system, method and computer program product according to various embodiments of this disclosure. In this regard, each box in the flow chart or block diagram can represent a module, a program segment, or a part of a code, and the above-mentioned module, program segment, or a part of a code contains one or more executable instructions for realizing the specified logical function. It should also be noted that in some alternative implementations, the functions marked in the box can also occur in a different order from the order marked in the accompanying drawings. For example, two boxes represented in succession can actually be executed substantially in parallel, and they can sometimes be executed in the opposite order, depending on the functions involved. It should also be noted that each box in the block diagram or flow chart, and the combination of the boxes in the block diagram or flow chart can be implemented with a dedicated hardware-based system that performs a specified function or operation, or can be implemented with a combination of dedicated hardware and computer instructions.

The units involved in the embodiments of this disclosure may be implemented by software or hardware, and the units described may also be arranged in a processor. The names of these units do not, in some cases, limit the units themselves.

It should be noted that, as another aspect, the present application also provides a storage medium, which may be included in an electronic device; or it may exist independently without being assembled into the electronic device. The above storage medium carries one or more programs, and when the above one or more programs are executed by an electronic device, the electronic device implements the method described in the following embodiments. For example, the electronic device may implement each step of the method applied to a proxy server, an IoT platform, or an IoT device.

In addition, the above-mentioned drawings are only schematic illustrations of the processes included in the method according to some exemplary embodiments of this disclosure, and are not intended to be limiting. It is to be understood that the processes shown in the above-mentioned drawings do not indicate or limit the time sequence of these processes. In addition, it is also to be understood that these processes can be performed synchronously or asynchronously, for example, in multiple modules.

Other embodiments of this disclosure can easily be conceived by those skilled in the art through considering the specification and practicing the invention disclosed herein. This application is intended to cover any variations, uses, or adaptations of this disclosure that follow the general principles of this disclosure and include common knowledge or customary technical means in the art that are not disclosed in this disclosure. The specification and examples are to be considered as exemplary only, and the true scope and spirit of this disclosure are indicated by the claims.

It should be understood that this disclosure is not limited to the exact structures that have been described above and shown in the drawings, and that various modifications and changes may be made without departing from the scope thereof. The scope of this disclosure is limited only by the appended claims.

1. A virtual reality interaction method, comprising:
collecting body posture information of a user in a real environment by using a posture tracking sensor, wherein the posture tracking sensor comprises a motion sensor provided corresponding to a position of a target skeletal muscle, and the motion sensor is configured to determine a joint motion angle of a corresponding joint;
collecting head position information of the user's head in the real environment by using a laser radar, and collecting head posture information of the user's head in the real environment by using an inertial measurement unit (IMU) sensor; and
configuring the body posture information, the head position information, and the head posture information as full-body posture information of the user, and mapping a virtual object corresponding to the user in a virtual reality environment according to full-body posture information.

2. The virtual reality interaction method according to claim 1, wherein the motion sensor comprises: a skin tension strain gauge and an electromyographic signal electrode configured to calculate the joint motion angle.

3. The virtual reality interaction method according to claim 2, further comprising:
collecting magnitude and direction data of skeletal muscle stress through the skin tension strain gauge;
collecting corresponding electromyographic current data through the electromyographic signal electrode; and
determining the joint motion angle of the corresponding joint by querying a preset data table according to the electromyographic current data, the magnitude and direction data of the skeletal muscle stress.

4. The virtual reality interaction method according to claim 1, further comprising:
acquiring a user image of the user, and identifying the user image to acquire a corresponding body region image; and
calibrating the body region image to obtain length parameters corresponding to respective joints.

5. The virtual reality interaction method according to claim 1, further comprising:
sending the full-body posture information of the user to a server side, thereby causing the server side to display, based on the full-body posture information, the virtual object corresponding to the user in the virtual reality environment.

6. The virtual reality interaction method according to claim 5, further comprising:
configuring, in the virtual reality environment, a user virtual space for the virtual object corresponding to the user; and
displaying, in the user virtual space, the virtual object of the user based on the full-body posture information.

7. The virtual reality interaction method according to claim 6, further comprising:
calibrating a coordinate sub-system corresponding to the user virtual space and a coordinate system corresponding to the virtual reality environment, thereby determining a coordinate transformation matrix between the coordinate sub-system and the coordinate system; and
determining, based on the coordinate transformation matrix and according to the full-body posture information of the virtual object in the user virtual space, the full-body posture information of the virtual object in the coordinate system.

8. The virtual reality interaction method according to claim 1, wherein the laser radar and the IMU sensor are arranged on a VR helmet worn by the user.

9. A virtual reality interaction apparatus, characterized in comprising:
a posture tracking sensor, adapted to collect body posture information of a user in a real environment, wherein the posture tracking sensor comprises a motion sensor provided corresponding to a position of a target skeletal muscle, and the motion sensor is configured to determine a joint motion angle of a corresponding joint;
a laser radar, adapted to collect head position information of the user's head in the real environment;
an inertial measurement unit (IMU) sensor, adapted to collect head posture information of the user's head in the real environment; and
a processor, adapted to configure the body posture information, the head position information, and the head posture information as full-body posture information of the user, and map a virtual object corresponding to the user in a virtual reality environment according to the full-body posture information.

10. A virtual reality interaction system, comprising:
a user terminal device, configured to collect user data, wherein the user data comprises full-body posture information of a user in a real environment, and the full-body posture information comprises head position information, head posture information, and body posture information; and
a server side, configured to acquire user data of multiple users, and display, according to correspondences between the multiple users and virtual objects in a virtual reality environment, a virtual object corresponding to the user based on the full-body posture information in the virtual reality environment.

11. A storage medium having a computer program stored thereon, wherein the computer program, when being executed by a processor, is used for implementing the virtual reality interaction method according to claim 1.

12. An electronic device, comprising:
a processor; and
a memory, configured to store executable instructions of the processor;
wherein the processor is configured to, through executing the executable instructions, implement the virtual reality interaction method according to claim 1.

13. The virtual reality interaction apparatus according to claim 9, wherein the motion sensor comprises: a skin tension strain gauge and an electromyographic signal electrode configured to calculate the joint motion angle.

14. The virtual reality interaction apparatus according to claim 13, wherein:
the skin tension strain gauge is configured to collect magnitude and direction data of skeletal muscle stress through the skin tension strain gauge;
the electromyographic signal electrode is configured to collect corresponding electromyographic current data through the electromyographic signal electrode; and
the motion sensor is configured to determine the joint motion angle of the corresponding joint by querying a preset data table according to the electromyographic current data, the magnitude and direction data of the skeletal muscle stress.

15. The virtual reality interaction apparatus according to claim 9, further comprising:
an image sensor, configured to acquire a user image of the user;
wherein the processor is further configured to: identify the user image to acquire a corresponding body region image; and calibrate the body region image to obtain length parameters corresponding to respective joints.

16. The virtual reality interaction apparatus according to claim 9, wherein the processor is further configured to:
send the full-body posture information of the user to a server side, thereby causing the server side to display, based on the full-body posture information, the virtual object corresponding to the user in the virtual reality environment.

17. The virtual reality interaction apparatus according to claim 16, wherein the processor is further adapted to:
configure, in the virtual reality environment, a user virtual space for the virtual object corresponding to the user; and
display, in the user virtual space, the virtual object of the user based on the full-body posture information.

18. The virtual reality interaction apparatus according to claim 6, wherein the processor is further configured to:
calibrate a coordinate sub-system corresponding to the user virtual space and a coordinate system corresponding to the virtual reality environment, thereby determining a coordinate transformation matrix between the coordinate sub-system and the coordinate system; and
determine, based on the coordinate transformation matrix and according to the full-body posture information of the virtual object in the user virtual space, the full-body posture information of the virtual object in the coordinate system.

19. The virtual reality interaction apparatus according to claim 9, wherein the laser radar and the IMU sensor are arranged on a VR helmet worn by the user.
